(19) United States
(12) Patent Application Publication
(10) Pub. No.: US 2016/0255985 A1
(43) Pub. Date: Sep. 8, 2016

(54) ANTHROPOMORPHIC HOLDER FOR REUSABLE COFFEE FILTER

(71) Applicants: Jeffrey A. Barshinger, Red Lion, PA (US); Michelle Lynn Barshinger, Red Lion, PA (US)

(72) Inventors: Jeffrey A. Barshinger, Red Lion, PA (US); Michelle Lynn Barshinger, Red Lion, PA (US)

(21) Appl. No.: 14/837,716

(22) Filed: Aug. 27, 2015

Related U.S. Application Data
(60) Provisional application No. 62/017,894, filed on Jun. 27, 2014.

(51) Int. Cl. A47J 31/06; A47J 47/16

(52) U.S. Cl. CPC A47J 31/06; A47J 47/16

(57) ABSTRACT

An anthropomorphic figurine for holding filter cartridges, such as for a single cup coffee maker. The figurine has upper appendages that are curled to define a holding receptacle for a filter cartridge. The figurine may also include lower appendages that form a notch for holding a lid of a reusable filter cartridge. The head of the figurine is adapted to hold a scoop, which may be shaped as a ball cap.

### CROSS-REFERENCE TO RELATED APPLICATION

This application claims the benefit of priority of U.S. provisional application No. 62/017,894, filed Jun. 27, 2014, the contents of which are herein incorporated by reference.

### BACKGROUND OF THE INVENTION

The present invention relates to coffee making equipment and, more particularly, to a holder for single serving coffee filter cartridges.

There is presently a wide array of items available for making coffee. A recent design that continues to be popular is the single serving coffee cup having a cartridge containing filter and the coffee grounds for brewing. Of these coffee makers, the Keurig remains one of the most popular. The Keurig coffee maker is primarily designed with single use disposable cartridge containing the coffee grounds and filter element. More recently, there are reusable filter elements for use with these machines. The reusable elements permit the user to select their own grounds, or add freshly ground coffee beans to the filter in order to brew their coffee.

The problem is having a place to put reusable coffee filters once they are washed and need to be dried. Alternatively, the user is faced with the predicament of not having a place to store reusable coffee filters when they are not being used.

They do not provide the buyer with any options nor offer the appeal of having your favorite sports team logo or mascot displayed.

As can be seen, there is a need for a filter holder among very few choices on the market for reusable coffee filter holders and none have a sports theme or a built-in coffee measuring spoon. It gives more choices based on sports interest.

### SUMMARY OF THE INVENTION

In one aspect of the present invention, an apparatus for holding a reusable filter cartridge includes an anthropomorphic figurine having a head portion, an upper appendage extending from an upper portion of a torso of the figurine. The upper appendages are curled defining a holding receptacle adapted to receive one of a filter element or a cartridge housing. In some embodiments, the upper appendages are arms, and the arms are curled inwardly to define the holding receptacle. The upper appendage may also be disproportionately sized hand elements defining the holding receptacle. In preferred aspects of the invention, the holding receptacle is adapted to receive a generally conical cylindrical shape.

In other aspects of the invention, a lower appendage extends from a lower portion of the torso of the figurine wherein the lower appendage define a notch, that is adapted to receive a lid for a reusable filter cartridge. The lower appendage may also extend so as to position the anthropomorphic figurine in a seated position. Alternatively, the lower appendage are formed as a disproportionately shaped foot element.

In yet other aspects of the invention the apparatus may also include a scoop, formed in the shape of a cap, wherein a handle of the scoop defines a bill of the cap. The head is adapted to receive the scoop, more preferably in an inverted position.

These and other features, aspects and advantages of the present invention will become better understood with reference to the following drawings, description and claims.

### BRIEF DESCRIPTION OF THE DRAWINGS

FIG. 1 is a perspective view of an embodiment of an anthropomorphic character holder for a reusable coffee filter.

FIG. 2 is an exploded perspective view of an embodiment of an anthropomorphic character holder for a reusable coffee filter.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an anthropomorphic figurine for holding the elements of a reusable coffee cartridge.

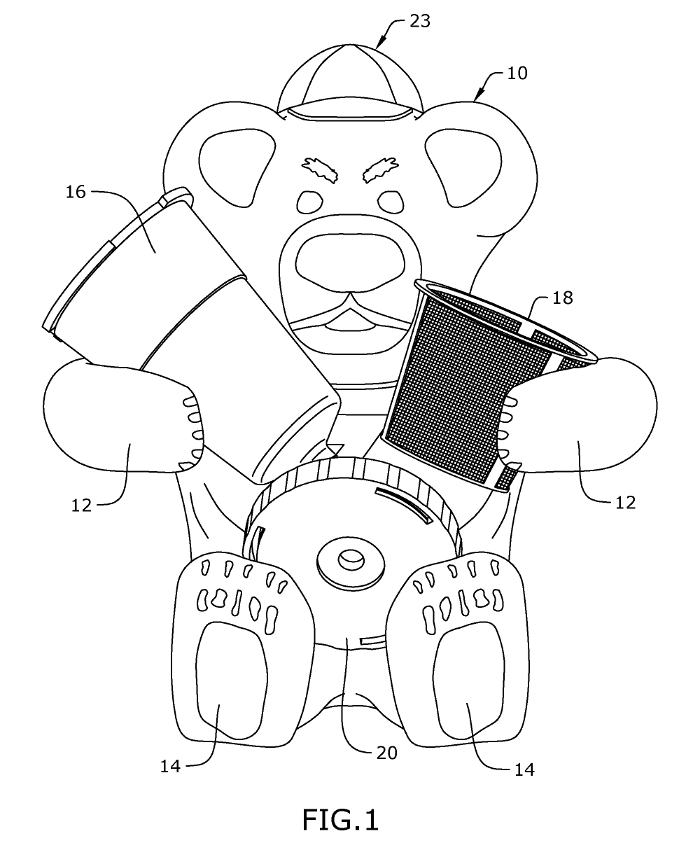

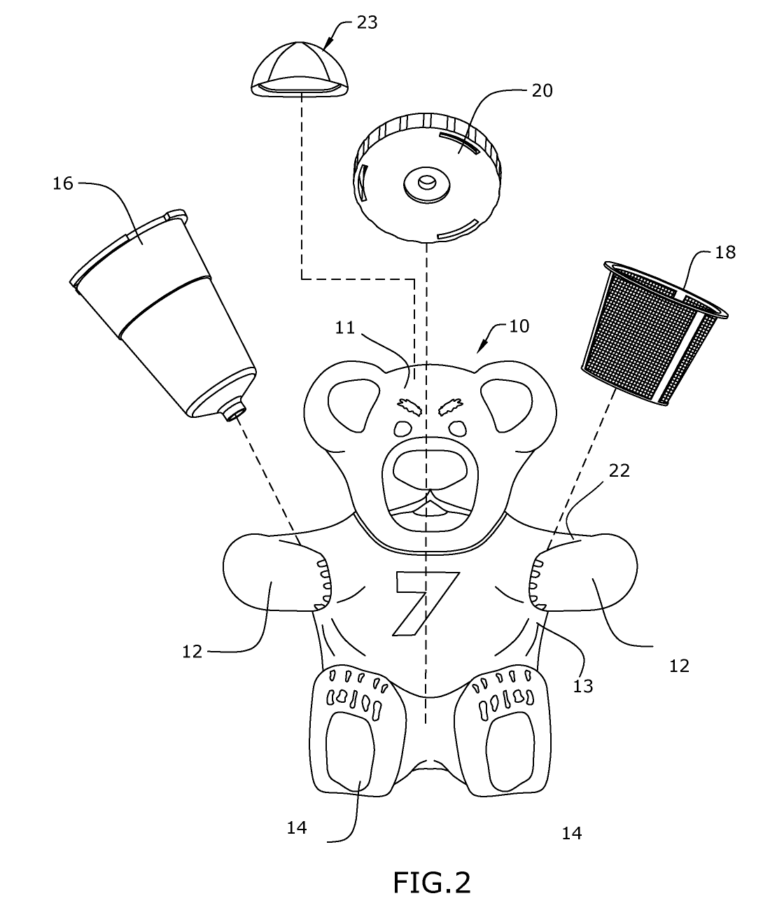

As seen in reference to FIGS. 1 and 2 the cartridge holder of the present invention includes an anthropomorphic figurine 10 that is posed to hold a coffee filter cartridge. The coffee filter cartridge may be a disposable coffee filter containing coffee grounds for brewing a cup of coffee. The coffee filter may also be a one-piece, reusable coffee cartridge with a flip-top lid. In a preferred embodiment, the coffee filter cartridge may comprise a reusable coffee cartridge, such as the Keurig, K-Cup, manufactured by Keurig Green Mountain, Inc., 33 Coffee Lane, Waterbury, Vt. 05676 USA.

For clarity in understanding the invention, the reusable coffee cartridge includes a filter element 18, a cartridge housing 16, and a lid 20. The filter element 18 is received within the cartridge housing 16. A user may add coffee grounds to the filter element 18 either before or after inserting the filter element 18 within the cartridge housing 16. After adding the coffee the user secures the lid 20 to the cartridge housing 16.

As will be appreciated, the reusable coffee cartridge and its associated parts should be kept grouped together when not in use or when drying. According to aspects of the present invention, the anthropomorphic figurine 10, comprises a character having a head portion 11, a pair of upper appendages 12 extending from a torso or main body 13 of the figurine 10. The upper appendages 12 may be curled arms so as to form a crook or a holding receptacle 22 for one of the filter element 18 or the cartridge housing 16. As will be appreciated, the upper appendage 12 may be a wing, or other like anatomical feature associated with an animal. Alternatively, the upper appendages 12 may be over sized or disproportionately sized hands defining the holding receptacle 22. The hand appendage may also be a disproportionately sized paw, hoof, or similar anatomical feature. In some preferred embodiments, the holding receptacle 22 may be sized to uniquely hold one or the other of the cartridge housing 16 or filter element 18. The holding receptacle 22 may preferably have a generally conical cylinder shape so as to provide form fit the filter element 18 or cartridge housing 16.

The anthropomorphic figurine 10 may also have a pair of lower appendages 14, or a facsimiles thereof such as legs 14, or disproportionately sized feet 14. The lower appendages 14 preferably define a notch, shelf, ledge or other feature for retaining the lid 20 of the reusable coffee filter cartridge. The lower appendages 14 of the figurine 10 may be positioned to place the figurine 10 in a seated or standing posture.

As previously mentioned, the user fills the filter element 18 with coffee grounds. Normally the user will utilize a measuring scoop, which is another item in making coffee that one needs to keep track of. In a preferred embodiment of the invention, the anthropomorphic figurine 10 of the present also provides a holder for a built in scoop 23. In certain embodiments, the scoop resembles a cap 23 for the figurine 10. In this embodiment, the top of the figurine's head 11 provides a convenient, suitable and entertaining holder for the scoop 23.

As will be appreciated, the anthropomorphic figurine 10 may have a representation of any of a wide variety of characters, animals, cartoon figures, celebrities, or the like. By way of example, the figurine 10 may be formed so as to resemble any of a number of sports team mascots, such as a bear, depicted in the drawings, thereby providing a sports-themed holder, which makes it especially marketable to various sports fans. As such, the holder of the present invention is something they will want to have sitting on their kitchen counter, or otherwise in close proximity to their coffee maker.

The anthropomorphic figurine 10 of the present invention is preferably formed in an injection mold process, but may be formed in any suitable manner. The plastic should preferably be of a mildew resistant variety. The base, or bottom of the anthropomorphic figurine 10 may also include a rubberized, or cushioned grip-like material to keep from sliding when item or counter top is wet and to prevent marring of the counter top. The figurine 10 may also be painted with a mildew-resistant paint.

The bear or mascot holds the reusable single-cup coffee filter and canister in his arms, and the reusable coffee filter lid is held by his bottom paws. Or the carafe size filter, canister, and lid will be held by his bottom paws. The bear/mascot's hat is removable and used to scoop coffee into the reusable coffee filter when making coffee.

It should be understood, of course, that the foregoing relates to exemplary embodiments of the invention and that modifications may be made without departing from the spirit and scope of the invention as set forth in the following claims.

What is claimed is:

1. An apparatus for holding a filter cartridge, comprising:
an anthropomorphic figurine, comprising a head portion; and an upper appendage extending from an upper portion of a torso of said figurine, wherein said upper appendage is curled defining a holding receptacle adapted to receive the filter cartridge.

2. The apparatus of claim 1, wherein said upper appendage is an arm, wherein said arm is curled inwardly to define said holding receptacle.

3. The apparatus of claim 1, wherein said upper appendage is a disproportionately sized hand element defining said holding receptacle.

4. The apparatus of claim 1, wherein said holding receptacle is adapted to receive a generally conical cylindrical shape.

5. The apparatus of claim 4, further comprising:
a lower appendage extending from a lower portion of said torso of said figurine wherein said lower appendage defines a notch, wherein the notch is adapted to receive a lid for a reusable filter cartridge.

6. The apparatus of claim 5, wherein said lower appendage extends so as to position the anthropomorphic figurine in a seated position.

7. The apparatus of claim 5, wherein said lower appendage is formed as a disproportionately shaped foot element.

8. The apparatus of claim 1, further comprising:
a scoop formed in the shape of a cap, wherein a handle of the scoop defines a bill of the cap.

9. The apparatus of claim 8, wherein the head is adapted to receive the scoop.

10. The apparatus of claim 9, wherein the head is adapted to receive the scoop in an inverted position.

11. The apparatus of claim 1, wherein said filter cartridge is a disposable filter cartridge for a coffee maker.

12. The apparatus of claim 1, wherein said filter cartridge is a reusable filter cartridge for a coffee maker.
